(19) United States
(12) Patent Application Publication
(10) Pub. No.: US 2025/0316883 A1
(43) Pub. Date: Oct. 9, 2025

(54) ANTENNA AND COMMUNICATION SYSTEM FOR A BATTERY CELL

(71) Applicant: GM GLOBAL TECHNOLOGY OPERATIONS LLC, Detroit, MI (US)

(72) Inventors: Alok Warey, Novi, MI (US); Brian J. Koch, Berkley, MI (US); Jing Gao, Rochester, MI (US); Jason A Graetz, Calabasas, CA (US); Souren Soukiazian, Burbank, CA (US); Patrick J. Webb, Sunnyvale, CA (US); Chia-Ming Chang, Agoura Hills, CA (US); Daniel M. Zehnder, Los Angeles, CA (US); Hanseung Lee, Thousand Oaks, CA (US); Adam E Sorensen, Moorpark, CA (US)

(73) Assignee: GM GLOBAL TECHNOLOGY OPERATIONS LLC, Detroit, MI (US)

(21) Appl. No.: 18/626,464

(22) Filed: Apr. 4, 2024

(51) Int. Cl. H01Q 1/22; H01M 10/42; H01M 10/48; H01M 50/105; H01M 50/119; H01M 50/129; H01Q 1/36; H01Q 13/10

(52) U.S. Cl. CPC H01Q 1/22; H01M 10/425; H01M 10/48; H01M 50/105; H01M 50/119; H01M 50/129; H01M 2010/4278; H01Q 1/36; H01Q 13/10

(57) ABSTRACT

A wireless communication system for a battery cell incorporates an antenna for one-way or two-way wireless communication, wherein the antenna is an integral portion of the battery cell. This includes a battery cell including an anode, a separator, and a cathode that are disposed in a cavity that is formed in a flexible-walled container (pouch), a controller, and an antenna. The pouch includes a first wall that is opposed to a second wall, wherein the first wall and the second wall define the cavity. The first wall includes a metal foil that is laminated between an inner layer and an outer layer. The antenna is formed from a first portion of the metal foil of the first wall of the pouch.

### INTRODUCTION

A rechargeable energy storage system (RESS) is an electrochemical device that is capable of storing and releasing electrical energy to perform work. An RESS may be employed in a stationary energy storage system or in a mobile device, e.g., as part of an electric vehicle (EV). When employed as part of an EV, an electric drivetrain employs one or multiple electric machines to generate torque employing electrical energy derived at least in part from the RESS, with the generated torque being delivered to a drivetrain for tractive effort.

The RESS may include a battery pack composed of a plurality of battery cells, associated power electronics, and thermal regulation hardware, and may be controlled by a resident battery controller. The battery controller may include hardware and software elements that monitor the ongoing health of hardware and software components of the RESS, and control electrical charging and discharging operations. The controller may also monitor and report battery pack voltage, individual cell voltages and cell currents, states of charge, temperatures, and other parameters. The battery controller may also perform periodic cell balancing operations to equalize the states of charge of the various battery cells. This may include monitoring individual cell voltages to keep the battery cells within a permitted voltage window.

Communication between elements of a battery system may be accomplished via hard-wired and/or wireless communication devices and protocols.

### SUMMARY

The concepts described herein provide elements related to a wireless communication system for a battery cell that incorporates an embodiment of an antenna for one-way or two-way wireless communication, wherein the antenna is an integral portion of the battery cell.

The concepts described herein provide an antenna for a battery cell for one-way or two-way wireless communication, wherein the antenna is an integral portion of the battery cell.

An aspect of the disclosure may include a battery cell including an anode, a separator, and a cathode that are disposed in a cavity that is formed in a flexible-walled container (pouch), a controller, and an antenna. The pouch includes a first wall that is opposed to a second wall, wherein the first wall and the second wall define the cavity. The first wall includes a metal foil that is laminated between an inner layer and an outer layer. The antenna is formed from a first portion of the metal foil of the first wall of the pouch.

Another aspect of the disclosure may include the antenna being a conductive element that is formed from the first portion of the metal foil on the inner layer of the first wall, wherein the conductive element is electrically isolated from a remaining portion of the metal foil by removal of a sacrificial portion of the metal foil.

Another aspect of the disclosure may include the conductive element being in electrical contact with the controller via a conductive lead.

Another aspect of the disclosure may include the conductive element being a monopole, wherein a first end of the monopole is in electrical contact with the controller via a conductive lead.

Another aspect of the disclosure may include the conductive element being formed as a slot.

Another aspect of the disclosure may include the conductive element being an elongated lead that is formed in the first portion of the metal foil.

Another aspect of the disclosure may include the elongated lead that is formed in the first portion of the metal foil having one of a straight, spiral, serpentine, square wave, or zigzag arrangement.

Another aspect of the disclosure may include a controllable switch, wherein the elongated lead includes a first end, a middle portion, and a second end. A first end of the controllable switch is electrically connected to the middle portion and a second end of the controllable switch is electrically connected to the remaining portion of the metal foil.

Another aspect of the disclosure may include the controllable switch is operatively connected to the controller.

Another aspect of the disclosure may include an epoxy resin being affixed onto the first portion of the metal foil.

Another aspect of the disclosure may include a wireless communication system for a battery cell that includes a battery cell, a wireless communication controller, and an antenna. The battery cell includes a pouch having a first wall opposed to a second wall, wherein the first wall and the second wall define a cavity, and wherein the first wall includes a metal foil laminated between an inner layer and an outer layer. The antenna is a conductive element that is formed from a first portion of the metal foil on the inner layer of the first wall, wherein the conductive element is electrically isolated from a remaining portion of the metal foil by removal of a sacrificial portion of the metal foil. The conductive element is in electrical contact with the controller via a conductive lead.

Another aspect of the disclosure may include the wireless communication controller being powered by the battery cell.

Another aspect of the disclosure may include the conductive element of the antenna being configured as a monopole, wherein a first end of the monopole is in electrical contact with the controller via a conductive lead.

Another aspect of the disclosure may include the conductive element of the antenna being a slot antenna.

Another aspect of the disclosure may include a sensor; wherein the sensor is arranged to monitor the battery cell; wherein the sensor is in communication with the wireless communication controller; and wherein the antenna enables the wireless communication controller to wirelessly broadcast a message, wherein the message includes a parameter that is determined based upon the sensor being arranged to monitor the battery cell.

Another aspect of the disclosure may include an antenna for wireless communication on an electrified vehicle. A battery cell includes a pouch having a first wall opposed to a second wall, wherein the first wall and the second wall define a cavity, and wherein the first wall includes a metal foil laminated between an inner layer and an outer layer. The antenna includes a conductive element affixed to a first substrate, wherein the first substrate is a first portion of the inner layer of the first wall. The conductive element is an elongated lead that is formed from the metal foil and adjoins the first portion of the inner layer of the first wall.

Another aspect of the disclosure may include the elongated lead that is formed in the first portion of the metal foil being one of a straight, spiral, serpentine, square wave, or zigzag arrangement.

Another aspect of the disclosure may include the conductive element of the antenna being affixed to the inner layer, wherein the conductive element is an elongated lead that is formed from physical removal of a portion of the metal foil; and wherein the first end of the antenna is coupled to the wireless communication controller.

Another aspect of the disclosure may include an epoxy resin being affixed onto the first portion of the metal foil.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the claims.

### BRIEF DESCRIPTION OF THE DRAWINGS

One or more embodiments will now be described, by way of example, with reference to the accompanying drawings, in which:

FIG. 1 schematically illustrates a vehicle and electrified drivetrain having a battery system and a battery control system, in accordance with the disclosure.

FIG. 2 schematically illustrates a circuit topology for a battery controller system to effect wireless communication, in accordance with the disclosure.

FIG. 3 schematically illustrates a plurality of battery cells and a battery monitoring controller, in accordance with the disclosure.

FIG. 4 schematically illustrates a partial cutaway edge view of elements of an embodiment of a battery cell, in accordance with the disclosure.

FIG. 5 schematically illustrates a cutaway top view of an antenna formed on, by, and from a flexible-walled container (pouch) of a battery cell, in accordance with the disclosure.

FIG. 6 illustrates an embodiment of a notch antenna, in accordance with the disclosure.

FIG. 7 illustrates another embodiment of a slot antenna, in accordance with the disclosure.

FIG. 8 illustrates another embodiment of a monopole antenna having a square wave configuration, in accordance with the disclosure.

FIG. 9 illustrates another embodiment of a slot antenna element, in accordance with the disclosure.

FIG. 10 illustrates another embodiment of a monopole antenna element, in accordance with the disclosure.

FIGS. 11a, 11b, 11c, 11d, and 11e pictorially illustrate elements of process steps associated with fabrication of an antenna that is formed on and from a flexible-walled container (pouch) of a battery cell, in accordance with the disclosure.

The appended drawings are not necessarily to scale, and present a somewhat simplified representation of various features of the present disclosure as disclosed herein, including, for example, specific devices, dimensions, orientations, locations, and shapes. Details associated with such features will be determined in part by the particular intended application and use environment.

The present disclosure is susceptible to various modifications and alternative forms, and some representative embodiments have been shown by way of example in the drawings and will be described in detail herein. Novel aspects of this disclosure are not limited to the particular forms illustrated in the drawings. Rather, the disclosure is intended to cover modifications, equivalents, combinations, or alternatives falling within the spirit and scope of the disclosure as defined by the appended claims.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description to provide a thorough understanding of the embodiments disclosed herein, some embodiments may be practiced without some of these details. Moreover, for the purpose of clarity, certain technical material that is understood in the related art has not been described in detail to avoid unnecessarily obscuring the disclosure. Furthermore, the disclosure, as illustrated and described herein, may be practiced in the absence of an element that is not specifically disclosed herein.

The present disclosure is susceptible of being embodied in various forms. Representative examples of the disclosure are shown in the drawings and described herein in detail as non-limiting examples thereof. To that end, elements and limitations described herein, but not explicitly set forth in the claims, are not to be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including,” “containing,” “comprising,” “having,” and the like shall mean “including without limitation.” Moreover, words of approximation such as “about,” “almost,” “substantially,” “generally,” “approximately,” etc., may be used herein in the sense of “at, near, or nearly at,” or “within 0-5% of,” or “within acceptable manufacturing tolerances,” or logical combinations thereof.

As used herein, the term “system” refers to mechanical and electrical hardware, software, firmware, electronic control componentry, processing logic, and/or processor device, individually or in combination, including without limitation: application specific integrated circuit (ASIC), an electronic circuit, a processor (shared, dedicated, or group) that executes one or more software or firmware programs, memory device(s) that electrically store software or firmware instructions, a combinatorial logic circuit, and/or other components that provide the described functionality.

As employed herein, terms such as “vertical”, “horizontal”, “left”, “right”, “upper”, “lower”, “top”, “bottom” and similar expressions are non-limiting terms that merely describe the various elements as illustrated in the Figures, and are not intended to limit the scope of the disclosure.

As used herein, the term “electric machine” refers to a rotary electric motor/generator device including a rotor and a stator that is capable of converting electric power to mechanical power and/or converting mechanical power to electric power by electromagnetic effort.

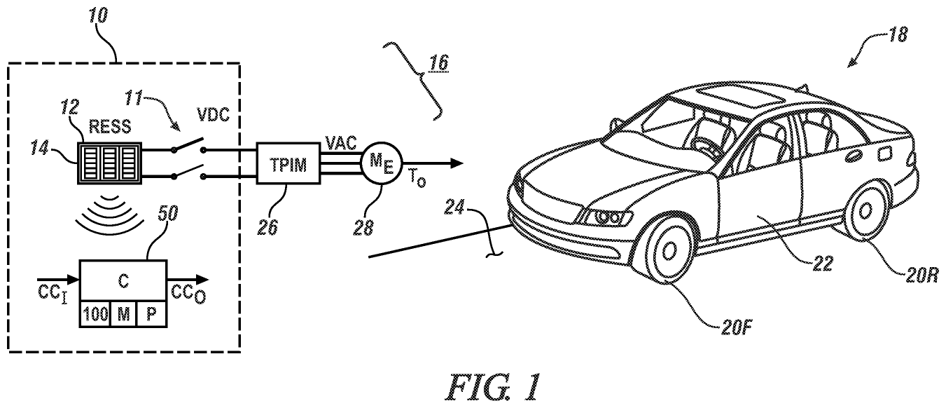

Referring to the drawings, wherein like reference numbers refer to the same or like components in the several Figures, FIG. 1 schematically illustrates elements of a vehicle 18 having an electrified drivetrain 16 that is composed of a battery system 10, a multi-phase power inverter (TPIM) 26, a multi-phase rotary electric motor/generator (electric machine) 28, and drive wheels 20F, 20R, the operations of which are monitored and controlled by a battery controller system 50. The battery system 10 has a multi-cell rechargeable energy storage system (RESS) 12 and a battery controller system (C) 50.

The RESS 12 includes a plurality of electrochemical battery cells 14 that are arranged or stacked in close proximity to one another. The RESS 12 is configured to have onboard cell sensing and cell data communication functions that are integrated directly into the structure of the RESS 12, with communication of the cell data performed wirelessly.

The RESS 12 may be employed as a high-energy/high-voltage power supply aboard the motor vehicle 18. In such an embodiment, the RESS 12 may be selectively disconnected via a set of high-voltage contactors 11 and configured to electrically energize a traction power inverter module (TPIM) 26. The TPIM 26 may contain multiple sets of power semiconductor switches and filtering components arranged in phase-specific switching legs. The power semiconductor switches may be field-effect transistors (FETs). In one embodiment, the FETs are GaN (Gallium Nitride) transistors. In one embodiment, the power semiconductor switches are integrated gate bipolar transistors (IGBTs). ON/OFF states of the individual power semiconductor switches may be controlled at a particular rate, e.g., using pulsewidth modulation. Switching control thus enables the TPIM 26 to receive a DC voltage (VDC) from the RESS 12 and to output a polyphase/AC voltage (VAC). Phase windings of the electric machine (ME) 28 may be electrically connected to the TPIM 26, as noted above, such that the output torque (arrow T_{O}) from the electric machine 28 is ultimately delivered to a coupled load, in this instance the road wheels 20F and/or 20R in either a torque generative mode or a torque reactive mode.

The battery cells 14 of the RESS 12 may be recharged via an offboard charging station and/or via onboard regeneration. Cell data such as individual cell or cell group voltages, charging and discharging electrical currents, respectively, to and from the battery cells or cell groups, and temperature measurements sampled at various locations within the battery system may be collected, monitored, and controlled over time by the battery controller. The battery controller system 50 may be configured to automatically adjust battery control parameters based on the collected cell data.

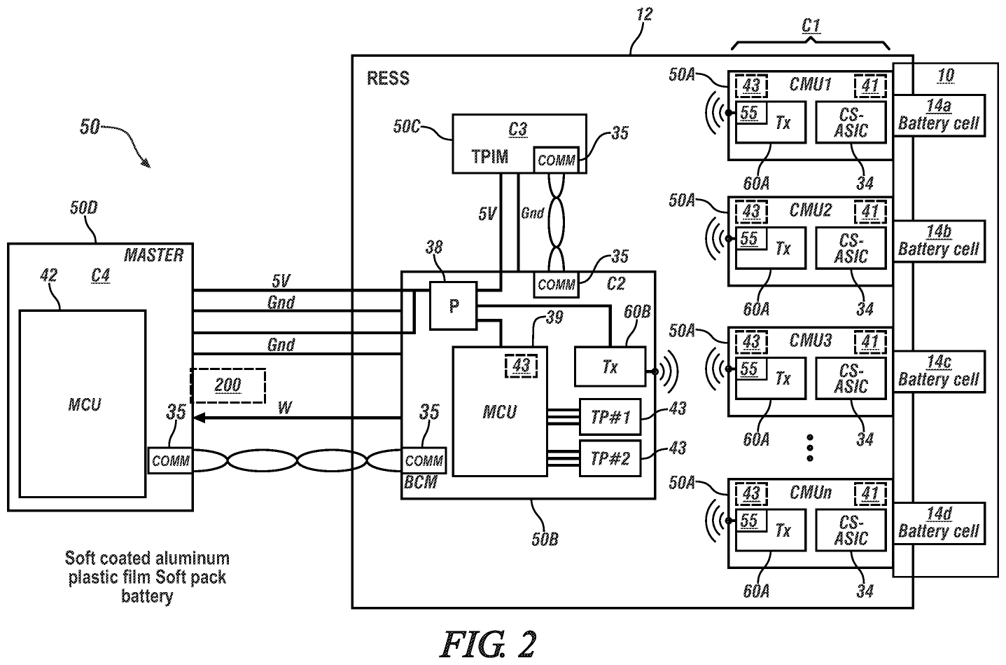

The battery controller system 50 of the battery system 10 described herein is embodied as multiple embedded controllers that collectively enable cell monitoring and data transfer functions to occur within the battery system 10 over hardwired connections and/or via secured wireless communication devices and protocols. The battery controller system 50 is depicted schematically in FIG. 1 as a unitary device solely for illustrative simplicity and descriptive clarity. FIG. 2 illustrates one detailed embodiment of a controller architecture of the battery controller system 50.

Referring again to FIG. 1, the RESS 12 is configured to have onboard cell sensing and cell data communication elements that are integrated directly into the structure, with communication of at least a portion of the cell data being performed wirelessly via the battery controller system (C) 50.

The battery controller system 50 is configured to monitor the RESS 12.

The controller 50 includes a controller 100, a memory (M) and a processor (P), with the example implementation of FIG. 2 or other hardware implementations not specifically depicted in the Figures possibly including several memory and/or processor devices, locations, and hardware configurations within the scope of the disclosure. Collectively, the various controllers making up the battery controller system 50 include controller-executable instruction sets including calibrations and look-up tables that are programmed to monitor and regulate ongoing thermal and electrical operations of the battery system 10 regularly, periodically, and/or in response to an event. The constituent controllers of the battery controller system 50 may selectively execute other software programs, including, e.g., cell balancing, health monitoring, electric range estimation, and/or powertrain control operations, with such applications being understood in the art and therefore not described herein.

The term “controller” and related terms such as microcontroller, control, control unit, processor, etc. refer to one or various combinations of Application Specific Integrated Circuit(s) (ASIC), Field-Programmable Gate Array(s) (FPGA), electronic circuit(s), central processing unit(s), e.g., microprocessor(s) and associated non-transitory memory component(s) in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning, buffer circuitry and other components, which can be accessed by and executed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables. Each controller executes control routine(s) to provide desired functions. Routines may be executed at regular intervals, for example every 100 microseconds during ongoing operation. Alternatively, routines may be executed in response to occurrence of a triggering event. Communication between controllers, actuators and/or sensors may be accomplished using a direct wired point-to-point link, a networked communication bus link, a wireless link, or another communication link. Communication includes exchanging data signals, including, for example, electrical signals via a conductive medium; electromagnetic signals via air; optical signals via optical waveguides; etc. The data signals may include discrete, analog and/or digitized analog signals representing inputs from sensors, actuator commands, and communication between controllers.

The term “signal” refers to a physically discernible indicator that conveys information, and may be a suitable waveform (e.g., electrical, optical, magnetic, mechanical, or electromagnetic), such as DC, AC, sinusoidal-wave, triangular-wave, square-wave, vibration, and the like, that is capable of traveling through a medium.

The terms “calibration”, “calibrated”, and related terms refer to a result or a process that correlates a desired parameter and one or multiple perceived or observed parameters for a device or a system. A calibration as described herein may be reduced to a storable parametric table, a plurality of executable equations or another suitable form that may be employed as part of a measurement or control routine.

A parameter is defined as a measurable quantity that represents a physical property of a device or other element that is discernible using one or more sensors and/or a physical model. A parameter can have a discrete value, e.g., either “1” or “0”, or can be infinitely variable in value.

The battery controller system 50 shown in FIG. 1 receives input signals (arrow CC_{I}) and transmits output signals (arrow CC_{O}) to change or maintain a present operating state of the battery system 10. The battery controller system 50 is embodied as multiple controllers as noted above, e.g., electronic control units and/or application-specific integrated circuits (ASICs) each having or being able to access the requisite memory (M) and processor (P), as well as other associated hardware and software, e.g., a clock or timer, input/output circuitry, etc.

The battery system 10 may be deployed in various stationary or mobile applications or systems, including but not limited to road, air, water, or rail vehicles, agricultural equipment, robots, stationary or mobile powerplants, and other mobile or stationary systems. An application of the present battery system 10, and in particular the RESS 12 thereof, is a high-energy direct current (DC) power supply for use in an electrified drivetrain 16. Such an electrified drivetrain 16 may be used in some embodiments to propel a motor vehicle 18, e.g., an operator-driven or autonomously driven passenger or commercial road vehicle. To do so, the electrified drivetrain 16 may be controlled to generate and deliver output torque (arrow T_{O}) to respective front and/or rear road wheels 20F and/or 20R mounted in a body 22 of the motor vehicle 18. Rotation of the road wheels 20F and/or 20R in an all-electric or hybrid-electric drive mode thus propels the motor vehicle 18 along a road surface 24.

FIG. 2 schematically illustrates a non-limiting example of a controller architecture for the battery controller system 50 that is illustrated in FIG. 1, which may be embedded within the battery system 10 and used to determine cell data for each respective battery cell 14 and/or stacks thereof. Such cell data is reported as part of the input signals (arrow CC_{I}) via a hardwired or a wireless/radiofrequency (RF) transmission, e.g., over a secure RF network at 2.4 GHz or another application-suitable frequency. The embedded controllers used to construct the battery controller system 50 may be positioned a distance apart from each other, e.g., between 0.1 m and 0.5 m apart, and therefore when wireless/RF communications are employed, the particular communications protocols used to implement the present teachings may be selected in accordance with the distance of such separation, and with due consideration to electromagnetic interference and other potential sources of signal noise.

The battery controller system 50 is composed with a plurality of cell sense controllers or cell measurement units (CMUs) 50A, battery monitoring controller (BMC) 50B, TPIM controller including a battery disconnect service board (BDSB) 50C, and a master controller 50D. The battery controller system 50 includes a wireless network employing the above-noted embedded controllers.

The CMUs 50A are embedded within individual battery cells of the RESS 12, with the collective set of controllers 50A collectively indicated as C1. For instance, the RESS 12 may be constructed from a quantity of (n) battery cells 14, indicated as 14a, 14b, 14c, . . . 14n, with each battery cell having a respective CMU, i.e., CMU1, CMU2, CMU3, . . . , CMUn 50A. Each CMU 50A is equipped with or in communication with one or multiple sensors 41 that are arranged to monitor the respective battery cell 14 via a battery cell sensing controller 34, and a wireless node (T_{X}) 60A that includes a cell antenna 55. In one embodiment, each CMU 50A may be equipped with a location identifier 43. Alternatively, or in addition, the BMC 50B may be equipped with a location identifier 43.

The sensors 41 are illustrated collectively, and may include one of or a combination of a temperature sensor, a voltage sensor, a current sensor, a gas detection sensor, a pressure sensor, or another sensor that is arranged to monitor a parameter of the respective battery cells 14. The sensors 41, wireless nodes 60A and battery cell sensing controller 34 of the embedded wireless CMU 50A enable direct battery cell sensing and wireless communication of sensed cell data to BMC 50B, labeled C2.

The BMC 50B may reside on or in close proximity to the RESS 12. In turn, the BMC 50B is connected to and magnetically isolated from a battery disconnect service board (BDSB) 50C and a master controller 50D, with the BDSB 50C and the master controller 50D respectively labeled C3 and C4. The BMC 50B includes wireless node 60B.

Communication between the plurality of CMUs 50A and the BMC 50B may occur wirelessly between wireless node(s) 60A and wireless node 60B. The communication may employ a 2.4 GHz wireless protocol over a secure wireless network via the wireless node(s) 60A and wireless node 50B, such that cell data measured by the individual CMUs 50A may be transmitted via the wireless node(s) 60A and wireless node 60B to the BMC 50B using low-power radio waves. The 2.4 GHz protocol generally encompasses a frequency range of about 2.402-2.480 GHz. Other RF frequency ranges may be used within the scope of the present disclosure. Likewise, techniques such as Time Synchronized Channel Hopping (TSCH) may be used, or the IEEE 802.15.4e Standard for Local and Metropolitan Area Networks, or another communication standard.

The BDSB 50C, which along with the BMC 50B may be equipped with its own communication (COMM) chip 35. The BDSB 50C may be programmed with battery-level tasks such as monitoring pack voltage, current, and other values for the RESS 12 as a whole. The BDSB 50C may be electrically connected to the battery controller 50B via 5V or other suitable low-voltage power lines and electrical ground (Gnd).

As part of programmed functionality of the BDSB 50C, the BDSB 50C may, in response to predetermined conditions and/or detected electrical faults, command or request opening of the contactors 11 of FIG. 1 to thereby disconnect the RESS 12.

The BMC 50B may be configured as a control board that receives wired or wirelessly communicated/RF data from the various CMUs 50A and, at times, other communicated data from the BDSB 50C. In the illustrated configuration, the BMC 50B includes a power supply (P) 38, the above-noted communications chip 35, and wireless node 60B. The power supply 38 may be embodied as a small low-voltage lithium-ion battery or other suitable device, which in turn is connected to and powers a master control unit (MCU) 42, e.g., another ASIC or set of processors performing various programmed tasks in the overall management of the battery system 10.

Examples of tasks performed by the BMC 50B and/or the CMU 50A may include performance of threshold checks for sensed parameters. The threshold checks may include, e.g., comparing a measured cell voltage with a minimum threshold for the cell voltage, comparing a measured cell current with a maximum cell current threshold, comparing a measured temperature with a maximum temperature threshold. The threshold checks may also include comparing a measured time-rate of change of voltage with a maximum time-rate of change of voltage threshold, comparing a measured time-rate of change of current with a maximum time-rate of change of current threshold, or comparing a measured time-rate of change of temperature with a maximum time-rate of change of temperature threshold.

Each wireless node 60A includes hardware in the form of RF antenna 55 and peripherals, microcontroller (including a processor and one or multiple memory devices), and sensor interface (including, e.g., analog-to-digital converters, etc.). The sensor interface communicates with the battery cell sensing controller 34, or is integrated into battery cell sensing controller 34. The wireless node 60 also includes software applications, a secure RF protocol and an open RF protocol. The software applications may include, by way of non-limiting examples, sensor calibrations, thresholds for the cell voltage, cell current, temperature, pressure, gas constituents, etc. The wireless connectivity can include wireless connections to other on-vehicle wireless nodes via the RF antenna 55 and peripherals.

The wireless node 60A periodically monitors the one or multiple sensors 41 that are arranged to monitor the respective battery cell 14, and performs evaluations such as threshold checks of the cell voltage, cell current, temperature, pressure, gas constituents, etc., and time-rate changes in the cell voltage, cell current, temperature, pressure, gas constituents, etc., which indicate occurrence of a thermal runaway event or occurrence of another fault. The wireless node 60A employs the secure RF protocol to perform one-way or two-way communication between the wireless node 60B of the CMU 50A and the MCU 42 and/or other controllers. The wireless node 60A periodically monitors and evaluates signals from the plurality of sensors 41, employs calibrations, performs the aforementioned evaluations such as threshold checks, and employs the secure RF protocol to perform one-way or two-way communication with the MCU 42 and/or other controllers. The concepts of one-way or two-way communication refer to the wireless transmission and/or reception of radio signals, as appreciated by skilled practitioners. wireless transmission and/or reception of radio signals.

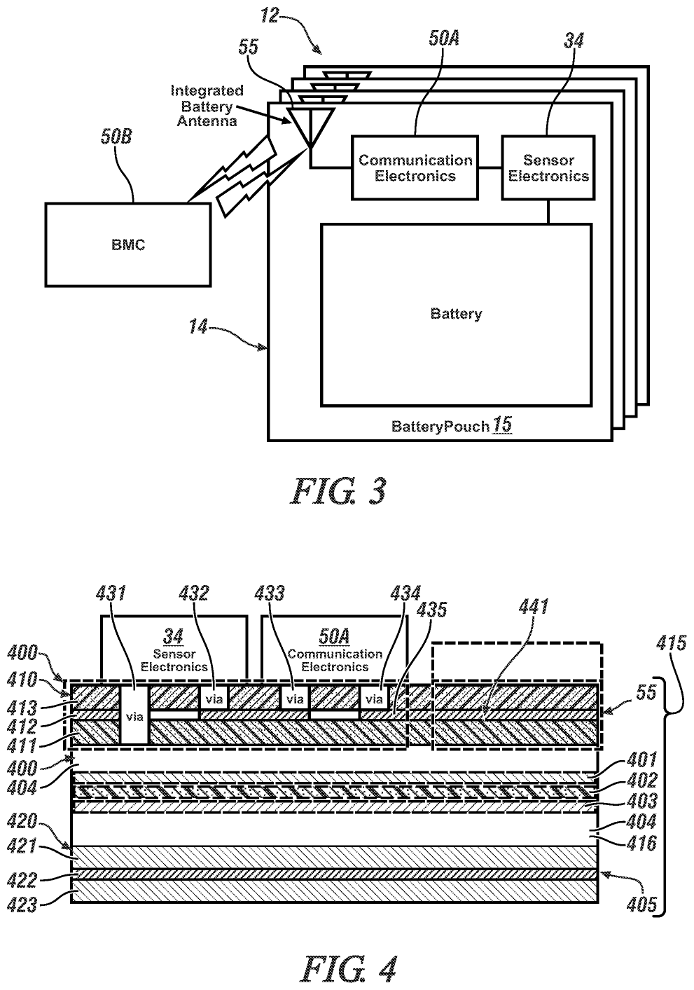

FIG. 3 schematically illustrates details of a portion of the RESS 12 and BMC 50B. The portion of the RESS 12 includes a plurality of battery cells 14 that are arranged in a stack, wherein the plurality of battery cells 14 includes respective CMUs 50A, antennas 55, and battery cell sensing controller 34.

Each of the battery cells 14 is an electrochemical device that includes an anode, a cathode, a separator, and electrolytic material that are sealably arranged within a flexible-walled container (pouch) 15. In one non-limiting embodiment, the battery cells 14 are lithium-ion battery cells.

The pouch 15 is designed to provide a lightweight, compact, and protective enclosure for the battery cell, while also allowing for efficient heat dissipation and safe venting of gases in case of thermal runaway.

The pouch 15 may take one of a variety of configurations. For example, in certain embodiments, as illustrated, the pouch 15 may be substantially rectangular. In other embodiments, although not illustrated, the pouch 15 may form a square, or another shape.

FIG. 4 schematically illustrates a partial cutaway edge view of elements of an embodiment of the battery cell 400 with monitoring and communication elements, including battery cell sensing controller 34 of wireless CMU 50A, antenna 55, sensor(s) 41, and wireless node (T_{X}) 60.

The battery cell 400 is composed of electrochemical cell elements including anode 401, separator 402, cathode 403, and electrolytic material 404, all of which are sealably contained within package 405. In one embodiment, and as illustrated, the package 405 is a pouch 415 having a first wall 410 that is arranged opposite to a second wall 420. The first wall 410 is bonded to or otherwise joined to the second wall 420 around an outer periphery, thus defining cavity 416. The anode 401, separator 402, cathode 403, and electrolytic material 404 are sealably inserted into the cavity 416.

At least the first wall 410 advantageously includes a metal foil 412 that is joined to and co-extensive with a polymer layer. In one embodiment, and as illustrated, the first wall 410 includes inner layer 411, metal foil layer 412, and outer layer 413, and the second wall 420 includes inner layer 421, metal foil layer 422, and outer layer 423.

The outer layers 413, 423 may be fabricated from a durable and flexible polymer material, such as polyethylene terephthalate (PET) or polyamide (PA), with a thickness ranging from 10 to 25 micrometers (μm). This layer provides mechanical protection and resistance to abrasion and punctures. In one embodiment, and as described herein, the inner layer 411 and outer layer 413 are electrically insulated layers, and have a maximum conductance that is in the range of 10E-14 to 10E-23 S/m (Siemens per meter) at 20 C temperature.

The metal foil layers 412, 422 function as barrier layers, and are fabricated from a thin layer of aluminum, aluminum alloy, or another metal, typically ranging from 6 to 12 μm in thickness. This layer serves as an effective barrier against moisture, oxygen, and other gases, thereby protecting the electrochemical battery cell from external contaminants and preventing leakage of electrolyte.

A sealant layer (not shown) may be fabricated from a polymer material such as polypropylene (PP) or polyethylene (PE), with a thickness ranging from 15 to 30 μm, is located between the outer layer and the barrier layer. This layer provides a reliable seal during the pouch manufacturing process, ensuring the integrity of the enclosure.

The inner layers 411, 421 may be fabricated from a polymer material, such as polypropylene (PP) or polyethylene (PE), with a thickness ranging from 20 to 40 μm. This layer is in direct contact with the electrochemical battery cell and is designed to be chemically compatible with the electrolyte and electrode materials. Overall, the laminate materials and associated thicknesses are selected to provide mechanical strength, chemical resistance, and thermal stability to withstand the operating conditions of the electrochemical battery cell.

The battery cell 400 includes battery cell sensing controller 34 of wireless CMU 50A, sensor(s) 41, and wireless node (T_{X}) 60 with antenna 55. The sensor(s) 41 are arranged to monitor one or multiple parameters of the battery cell 400 through a first via 431 that passes through the first wall 410. The sensor(s) 41 connects to and is in communication with the wireless node 60 through a second via 432 that passes through the outer layer 413 of the first wall 410, a segment of the metal foil 412, and a third via 433. The wireless node 60 connects to and is in communication with the antenna 55 through a conductive lead 435 that includes a fourth via 434, which leads to a first portion 441 of the metal foil 412.

The antenna 55 is a planar device that is formed in and formed from the first portion 441 of the metal foil 412 of the first wall 410 of the package 405, i.e., the pouch.

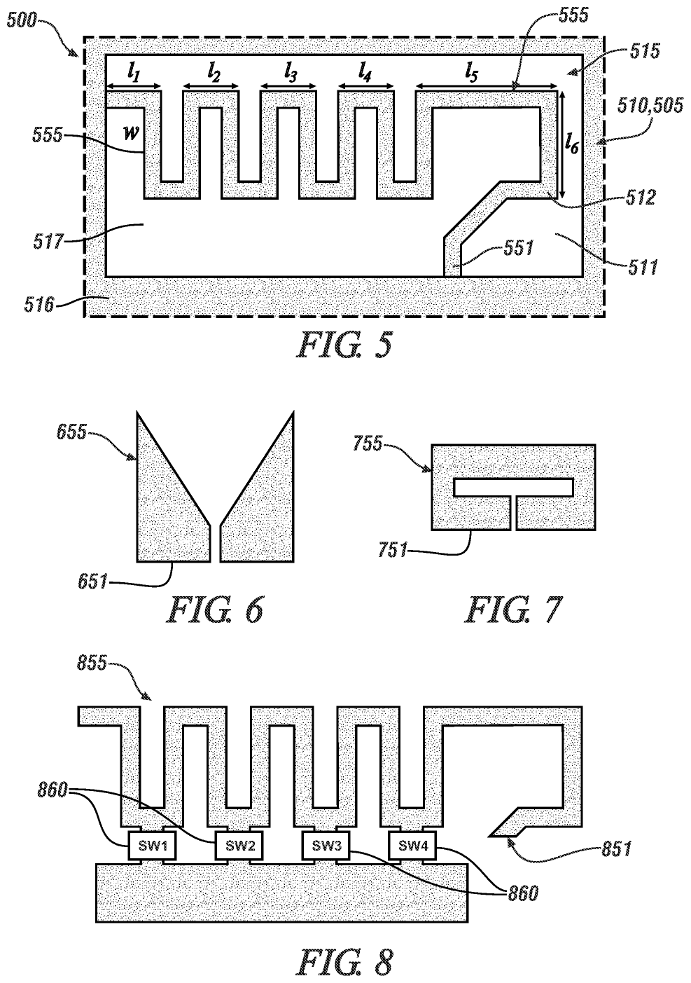

FIG. 5 illustrates a cutaway top view of antenna 555, which is formed in a first portion 515 of an embodiment of first wall 510 of package 505 of battery cell 500. The first wall 510 includes inner layer 511 and metal foil layer 512. An outer layer of the first wall 510 has been removed to facilitate illustration. The antenna 555 is formed in and by the first portion 515 of the metal foil 512 of the first wall 510, with the antenna 555 being disposed on and affixed to the inner layer 511. The inner layer 511 serves as a substrate. The antenna 555 is a conductive element that is formed from the first portion 515 of the metal foil 512, wherein the conductive element is electrically isolated from a remaining portion 516 of the metal foil by removal of a sacrificial portion 517 of the metal foil 512. As illustrated and in one embodiment, the antenna 555 is configured as a monopole element having a square wave, with a first end 551 that is able to couple to and communicate with an embodiment of the wireless node 60 described with reference to FIG. 2 through a conductive lead. By way of a non-limiting example, the conductive elements or leads have a conductance that ranges between 1E5 and 1E8 S/m (Siemens per meter) at a temperature of 20 C.

Alternatively, the antenna that is formed in a first portion 515 of an embodiment of first wall 510 of package 505 of battery cell 500 may be arranged as a slot antenna, an elongated slot antenna, a dipole antenna, etc., without limitation.

By way of a non-limiting example, FIG. 6 illustrates another embodiment of the antenna 655, which is configured as a notch antenna element, with a first end 651 that is able to couple to and communicate with an embodiment of the wireless node 60 described with reference to FIG. 2 through a conductive lead.

By way of a non-limiting example, FIG. 7 illustrates another embodiment of the antenna 755, which is configured as a slot antenna element, with a first end 751 that is able to couple to and communicate with an embodiment of the wireless node 60 described with reference to FIG. 2 through a conductive lead.

FIG. 8 illustrates another embodiment of the antenna 855, which is configured as a monopole antenna element having a square wave configuration, with a first end 851 that is able to couple to and communicate with an embodiment of the wireless node 60 described with reference to FIG. 2 through a conductive lead. In this embodiment, one or multiple switch elements (as shown) 860 are arranged at intervals along the length of the antenna 855 to controllably ground the antenna 855 and thus adjust the length of the antenna 855. The switch elements 860 are operatively connected to the wireless node 60 (illustrated with reference to FIG. 2), which operates to controllably adjust the length of the antenna 855 to enable short-distance communication or long-distance communication, depending on system needs and location of the respective battery cell in relation to BMC 50B (illustrated with reference to FIG. 2).

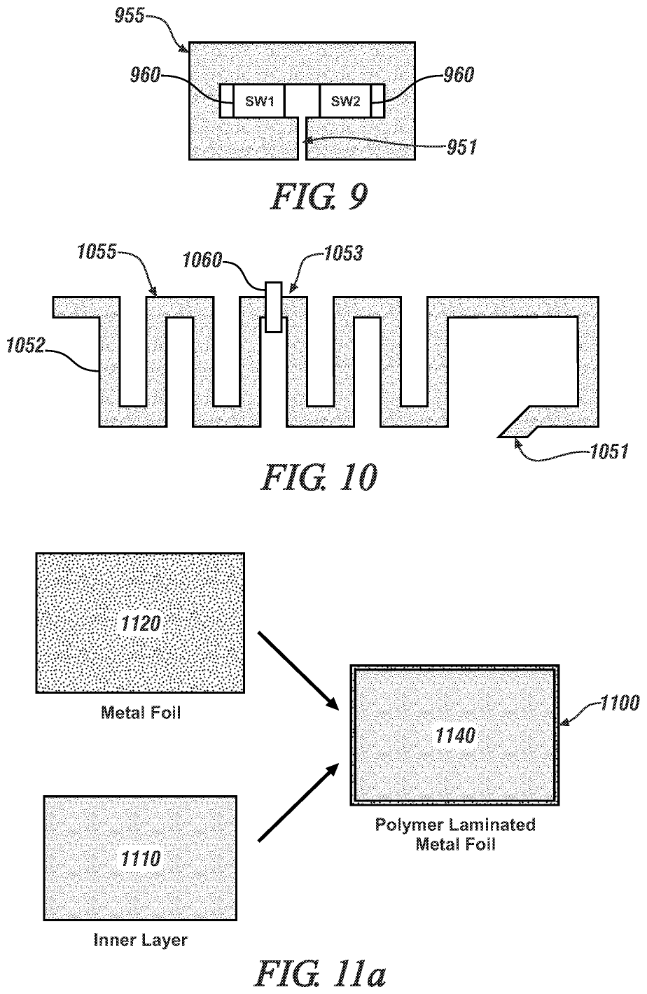

FIG. 9 illustrates another embodiment of the antenna 955, which is configured as a slot antenna element, with a first end 951 that is able to couple to and communicate with an embodiment of the wireless node 60 described with reference to FIG. 2 through a conductive lead. In this embodiment, one or multiple switch elements (as shown) 960 are arranged at intervals along the length of the antenna 955 to controllably short-circuit the antenna 955 and thus adjust the length of the antenna 955. The switch elements 960 are operatively connected to the wireless node 60 (illustrated with reference to FIG. 2), which can controllably adjust the length of the antenna 955 to enable short-distance communication or long-distance communication, depending on system needs and location of the respective battery cell in relation to BMC 50B (illustrated with reference to FIG. 2).

FIG. 10 illustrates another embodiment of the antenna 1055, which is configured as a monopole antenna element having a square wave configuration, with a first end 1051 that is able to couple to and communicate with an embodiment of the wireless node 60 described with reference to FIG. 2 through a conductive lead, a middle portion 1053, and a distal or second end 1052. In this embodiment, a single switch element (as shown) 1060 is arranged in the middle portion 1053 of the antenna 1055 to adjust the length of the antenna 1055. The switch element 1060 is operatively connected to the wireless node 60 (illustrated with reference to FIG. 2), which can controllably adjust the length of the antenna 1055 to enable short-distance communication or long-distance communication, depending on system needs and location of the respective battery cell in relation to BMC 50B (illustrated with reference to FIG. 2).

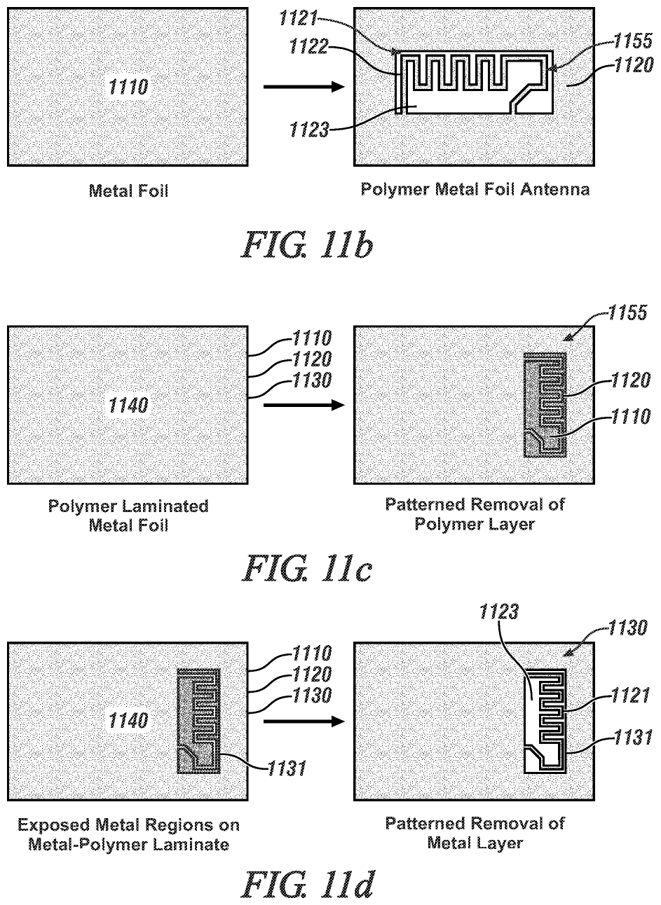

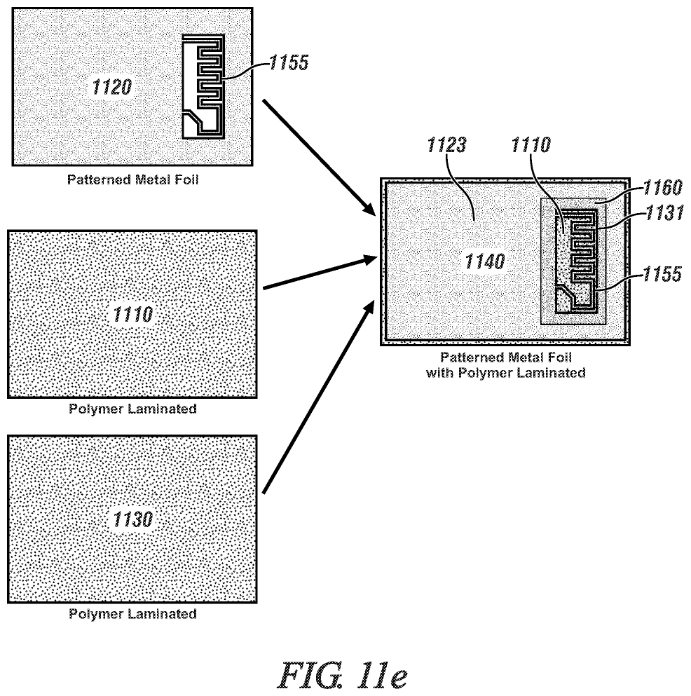

FIGS. 11a through 11e pictorially illustrate various elements of forming an embodiment of an antenna 1155 on a first wall 1100 of a flexible container (pouch) of a battery cell, wherein the first wall 1100 includes a metal foil 1120 that is laminated between an inner polylaminate layer (inner layer) 1110 and an outer polylaminate layer (outer layer) 1130, and the antenna 1155 is formed on and formed from a first portion of the metal foil of the first wall 1100 of the pouch.

FIG. 11a illustrates the inner layer 1110 and metal foil 1120. The metal foil is joined to the inner layer 1110 by a dry bonding process, an extrusion lamination process, or another process, and form a workpiece 1140 in the form of a polymer laminated metal foil. In one embodiment, outer layer 1130 may be joined to the metal foil 1120 and inner layer 1110 after an antenna is formed therein. In one embodiment, outer layer 1130 may be joined to the metal foil 1120 and inner layer 1110 before the antenna is formed therein, with a portion of the outer layer 1130 being removed prior to forming the antenna and subsequently replaced after the antenna has been formed in the metal foil 1120.

FIG. 11b illustrates the metal foil 1120, which has the antenna 1155 formed therein by a stamping process, a cutting process, or another process. In this illustration, the antenna 1155 may be formed in and formed from the metal foil 1120 prior to the metal foil 1120 being joined to the inner layer 1110. A first portion 1121, a remaining portion 1122, and a sacrificial portion 1123 are indicated. The antenna 1155 is the conductive element that is formed by removing the sacrificial portion 1123 from the first portion 1121.

FIG. 11c illustrates the workpiece 1140 in the form of the polymer laminated metal foil with inner layer 1110, outer layer 1130 and metal foil 1120. In this illustration, a first portion 1131 of the outer layer 1130 may be removed and thus expose the first portion 1121 of the metal foil 1120, and the inner layer 1110, using laser ablation or another process.

FIG. 11d illustrates the workpiece 1140 in the form of the polymer laminated metal foil with inner layer 1110, outer layer 1130 and metal foil 1120, with the first portion 1131 of the outer layer 1130 removed, and with the first portion 1121 of the metal foil 1120 having been removed. The sacrificial portion 1123 of the metal foil 1120 may be removed from the first portion 1121 by chemical etching or another process.

FIG. 11e illustrates the workpiece 1140 in the form of the polymer laminated metal foil with inner layer 1110, outer layer 1130 and metal foil 1120, with the antenna 1155 formed therein. The first portion 1131 of the outer layer 1130 may be encapsulated employing a second outer polylaminate layer 1160.

The concepts described herein provide an antenna for a pouch type battery cell, wherein the antenna is composed as a conductive element arranged on a first substrate. The battery cell may be a pouch having a first wall opposed to a second wall; wherein the first wall and the second wall define a cavity; wherein the first wall includes a metal foil laminated between an inner polymer layer and an outer polymer layer; wherein the first substrate is a portion of the inner polymer layer of the first wall of the pouch; and wherein the conductive element is an elongated lead that is an element of the metal foil of the first wall of the pouch.

The concepts described herein include an apparatus, system and method associated with a wireless monitoring system for a battery cell, including an antenna arranged on a flexible substrate.

The integrated battery pouch antenna may be fabricated employing a battery pouch having a patterned polymer/metal/polymer laminate structure in one embodiment. Alternatively, the antenna may be fabricated on a flexible conductive sheet that is integrated with the battery pouch, with potential benefits of having a conformal geometry and being lightweight. In addition, signal transmission distance of the antenna may be reconfigurable thereby enabling flexibility in installation in different vehicle systems. Together with embedded sensors, application-specific integrated circuit (ASIC) and communication electronics, the antenna may report and/or communicate wirelessly with a central battery health monitoring system.

In one embodiment, on-cell sensor electronics monitor and evaluate the battery and send information to the communication electronics. The communication electronics encrypts and amplifies the signal from the sensor electronics, and the signal is radiated in the free space through the integrated battery pouch antenna. The battery monitor main unit receives the signal and the battery information is recorded in real time. The integrated battery antenna may also receive a signal from the battery monitor main unit for taking an action like managing the battery operation or shutting down the battery if an urgent situation arises.

The concepts described herein include an apparatus, system and method associated with an antenna.

The concepts described herein include an apparatus, system and method associated with an antenna for a battery cell pouch.

The concepts described herein include an apparatus, system and method associated with an antenna arranged as an element of a battery cell pouch.

The concepts described herein include an apparatus, system and method associated with an antenna for a battery cell package.

The concepts described herein include an apparatus, system and method associated with a battery cell pouch including an antenna.

The concepts described herein include an apparatus, system and method associated with a battery cell including an antenna.

The concepts described herein include an apparatus, system and method associated with a monitoring system for a battery cell, including an antenna arranged on a flexible substrate.

The concepts described herein include an apparatus, system and method associated with an antenna for wireless communication between a battery cell and a health monitoring system, wherein the antenna is arranged on a flexible substrate.

While the best modes for carrying out the disclosure have been described in detail, those familiar with the art to which this disclosure relates will recognize various alternative designs and embodiments lying within the scope of the appended claims. It is intended that the matter contained in the above description and/or shown in the accompanying drawings shall be interpreted as illustrative only and not as limiting.

What is claimed is:

1. A battery cell, comprising:
a pouch defining a cavity;
an anode, a separator, and a cathode disposed in the cavity defined by the pouch; and
an antenna;
wherein the pouch includes a first wall opposed to a second wall, wherein the first wall and the second wall define the cavity;
wherein the first wall includes a metal foil laminated between an inner layer and an outer layer; and
wherein the antenna is formed from a first portion of the metal foil of the first wall of the pouch.

2. The battery cell of claim 1, wherein the antenna comprises a conductive element that is formed from the first portion of the metal foil on the inner layer of the first wall, wherein the conductive element is electrically isolated from a remaining portion of the metal foil by removal of a sacrificial portion of the metal foil.

3. The battery cell of claim 2, further comprising a controller; wherein the conductive element of the antenna is in electrical contact with the controller via a conductive lead.

4. The battery cell of claim 2, further comprising a controller; wherein the conductive element of the antenna comprises a monopole, wherein a first end of the monopole is in electrical contact with the controller via a conductive lead.

5. The battery cell of claim 2, wherein the conductive element is arranged as a slot antenna.

6. The battery cell of claim 2, wherein the conductive element comprises an elongated lead that is formed in the first portion of the metal foil.

7. The battery cell of claim 6, wherein the elongated lead that is formed in the first portion of the metal foil comprises the elongated lead having one of a straight, spiral, serpentine, square wave, or zigzag arrangement.

8. The battery cell of claim 7, further comprising a controllable switch;
wherein the elongated lead includes a first end, a middle portion, and a second end; and
wherein a first end of the controllable switch is electrically connected to the middle portion and a second end of the controllable switch is electrically connected to the remaining portion of the metal foil.

9. The battery cell of claim 8, further comprising a controller; wherein the controllable switch is operatively connected to the controller.

10. The battery cell of claim 1, further comprising another outer layer portion being affixed onto the first portion of the metal foil.

11. A wireless communication system for a battery cell, comprising:
a battery cell, a wireless communication controller, and an antenna;
wherein the battery cell includes a pouch having a first wall opposed to a second wall, wherein the first wall and the second wall define a cavity, and wherein the first wall includes a metal foil laminated between an inner layer and an outer layer;
wherein the antenna comprises a conductive element that is formed from a first portion of the metal foil on the inner layer of the first wall, wherein the conductive element is electrically isolated from a remaining portion of the metal foil by removal of a sacrificial portion of the metal foil; and
wherein the conductive element is in electrical contact with the controller via a conductive lead.

12. The wireless communication system of claim 11, wherein the wireless communication controller is powered by the battery cell.

13. The wireless communication system of claim 11, wherein the conductive element of the antenna is configured as a monopole, and wherein a first end of the monopole is in electrical contact with the controller via a conductive lead.

14. The wireless communication system of claim 11, wherein the conductive element of the antenna comprises a slot antenna.

15. The wireless communication system of claim 11, further comprising a controllable switch;
wherein the conductive element of the antenna includes a first end, a middle portion, and a second end; and
wherein a first end of the controllable switch is electrically connected to the middle portion of the conductive element of the antenna, and a second end of the controllable switch is electrically connected to the second end of the conductive element of the antenna; and
wherein the controllable switch is operatively connected to the controller.

16. The wireless communication system of claim 11, further comprising a sensor;
wherein the sensor is arranged to monitor the battery cell;
wherein the sensor is in communication with the wireless communication controller; and
wherein the antenna enables the wireless communication controller to wirelessly broadcast a message, wherein the message includes a parameter that is determined based upon the sensor being arranged to monitor the battery cell.

17. An antenna for a wireless communication system arranged on a vehicle, the antenna comprising:
a conductive element affixed to a first substrate, wherein the first substrate is a first portion of an inner layer of a first wall of a container for a battery cell;
wherein the conductive element is an elongated lead that is formed from the metal foil and adjoins the first portion of the inner layer of the first wall of the container;
wherein the container of the battery cell includes the first wall arranged opposite to a second wall, wherein the first wall and the second wall define a cavity, and wherein the first wall includes a metal foil laminated between an inner layer and an outer layer.

18. The antenna of claim 17, wherein the elongated lead that is formed from the first portion of the metal foil comprises the elongated lead having one of a straight, spiral, serpentine, square wave, or zigzag arrangement.

19. The antenna of claim 17, wherein the conductive element of the antenna is affixed to the inner layer;
wherein the conductive element is an elongated lead that is formed from physical removal of a portion of the metal foil; and
wherein a first end of the antenna is coupled to a wireless communication controller.

20. The antenna of claim 19, further comprising an epoxy resin being affixed onto the first portion of the metal foil.
